(19) United States
(12) Patent Application Publication
(10) Pub. No.: US 2015/0248343 A1
(43) Pub. Date: Sep. 3, 2015

(54) METHOD AND APPARATUS FOR IMPLEMENTING INSTRUMENTATION CODE

(71) Applicants: Razvan Ionescu, Bucharest (RO); Radu-Marian Ivan, Bucharest (RO); Ionut-Valentin Vicovan, Bucharest (RO)

(72) Inventors: Razvan Ionescu, Bucharest (RO); Radu-Marian Ivan, Bucharest (RO); Ionut-Valentin Vicovan, Bucharest (RO)

(73) Assignee: FREESCALE SEMICONDUCTOR, INC., Austin, TX (US)

(21) Appl. No.: 14/417,173

(22) PCT Filed: Jul. 27, 2012
(86) PCT No.: PCT/IB2012/053864

§ 371 Date: Jan. 26, 2015

(51) Int. Cl. G06F 11/36; G06F 9/44

(52) U.S. Cl. CPC G06F 11/3688; G06F 8/70

(57) ABSTRACT

A method and apparatus for implementing instrumentation code within application program code is provided. The method includes, within a software development tool, defining at least one instrumentation point within the application program code, associating at least one instrumentation code object with the at least one defined instrumentation point, the at least one instrumentation code object comprising instrumentation code, and causing the instrumentation code of the at least one instrumentation code object associated with the at least one instrumentation point to be incorporated into the application program code prior to compilation of the application program code.

### FIELD OF THE INVENTION

The field of this invention relates to a method and apparatus for implementing instrumentation code.

### BACKGROUND OF THE INVENTION

For embedded processing applications and the like, it is very important to analyse application execution during development. Instrumentation is a known technique for providing such analysis, and involves inserting instrumentation probes into application code to be analysed that will provide an indication of the application progress during execution. For example, instrumentation probes may be added to implement a trace or the like during execution. However, there is no easy way to insert such custom instrumentation probes into application code.

Conventional automated instrumentation techniques are typically limited to predefined, fixed code instrumentation and do not allow for custom code instrumentation. In particular, conventional automated instrumentation techniques do not provide enough flexibility to enable a user to define new types of instrumentation probes.

Manual custom instrumentation may be performed by directly writing instrumentation code into the application code. However, it is hard and error prone since it is requires directly editing the application code. Furthermore, manual custom instrumentation needs to be done by each user, with no control of instrumentation points and with no way to reuse a custom defined probe (code for instrumentation).

### SUMMARY OF THE INVENTION

The present invention provides a method of implementing instrumentation code within application program code, a non-transitory computer program product having executable program code stored therein for programming signal processing logic to perform a method of implementing instrumentation code within application program code, and an apparatus for implementing instrumentation code within application program code as described in the accompanying claims.

Specific embodiments of the invention are set forth in the dependent claims.

These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIG. 1 illustrates a simplified block diagram of an example of an apparatus for developing application program code.

FIG. 2 illustrates a simplified block diagram of an example of a software development tool.

FIGS. 3 and 4 illustrate simplified flowcharts of an example of a method of implementing instrumentation code within application program code.

### DETAILED DESCRIPTION

The present invention will now be described with reference to an integrated development environment (IDE) running on a conventional computer system. However, it will be appreciated that the present invention is not limited to the specific implementations herein described. For example, the present invention may equally be implemented within alternative systems and apparatuses for developing application programme code, and/or within alternative software development tools.

Furthermore, because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

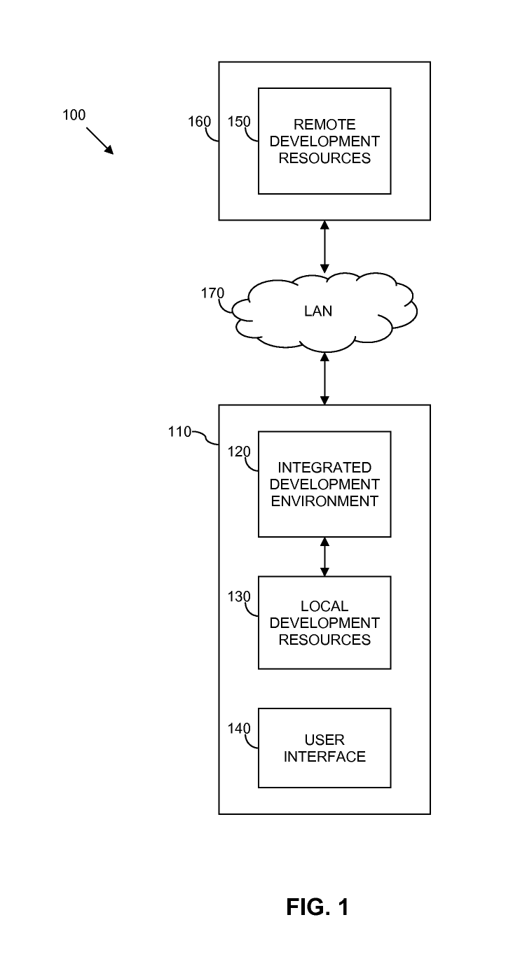

Referring first to FIG. 1, there is illustrated a simplified block diagram of an example of an apparatus 100 for developing application program code, such as application program code for execution within embedded systems. In the illustrated example, the apparatus 100 comprises a computer system 110 arranged to execute one or more software development tools, and in particular an integrated development environment (IDE) 120. For example, the computer system 110 may comprise one or more central processing units (CPUs) (not shown) on which such software development tools may run.

The computer system 110 further comprises one or more local development resources 130 to which the IDE running thereon has access to, for example stored within one or more areas of local memory such as stored within one or more local hard drives and/or optical drivers, and/or stored within one or more areas of local Flash memory and/or RAM (Random Access Memory). Such development resources may comprise, by way of example, application source code files for application program code under development, source code library files, trace files for application program code under development, IDE project files for application program code under development, etc.

The computer system 110 further comprises a user interface 140, for example comprising one or more input devices such as a keyboard, pointer device, etc. and one or more output devices such as a computer screen, etc. In this manner, a user is able to interact with the IDE running thereon.

The computer system 110 may have access to remote development resources 150, for example stored within a remote server 160 accessible via, say, a local area network (LAN) 170 or the like. Such remote development resource 150 may be downloaded from the remote server 160 to the computer system 110 as required, thereby adding to and/or replacing some or all of the local development resources 130. In this manner, public development resources may be accessed by the computer system 110. For example, application program code etc. for an application under development may be ‘checked out’ and downloaded for further development on the computer system 110. Furthermore, local development resources 130 may be uploaded to the remote server 160. In this manner, local development resources may be made available to other computer systems 110 via the remote server 160. For example, application program code etc. for an application under development that was being developed on the computer system 110 may be ‘checked in’ and uploaded to the remote server 160 when no longer being developed, thereby allowing further development of the application program code on other computer systems (not shown).

The IDE 120 itself may comprise computer program code executable on one or more central processing units, or other processing devices. As such, it is contemplated that the IDE 120 may be implemented by way of executable program code stored within a non-transitory computer program. As used herein, the expression non-transitory will be understood to refer to the non-ephemeral nature of the storage medium itself rather than to a notion of how long the stored information itself may persist in a stored state. Accordingly, memories that might otherwise be viewed, for example, as being volatile (such as many electronically-erasable programmable read-only memories (EPROM's) or random-access memories (RAM's)) are nevertheless to be viewed here as being ‘non-transitory’ whereas a signal carrier in transit is to be considered ‘transitory’ notwithstanding that the signal may remain in transit for a lengthy period of time.)

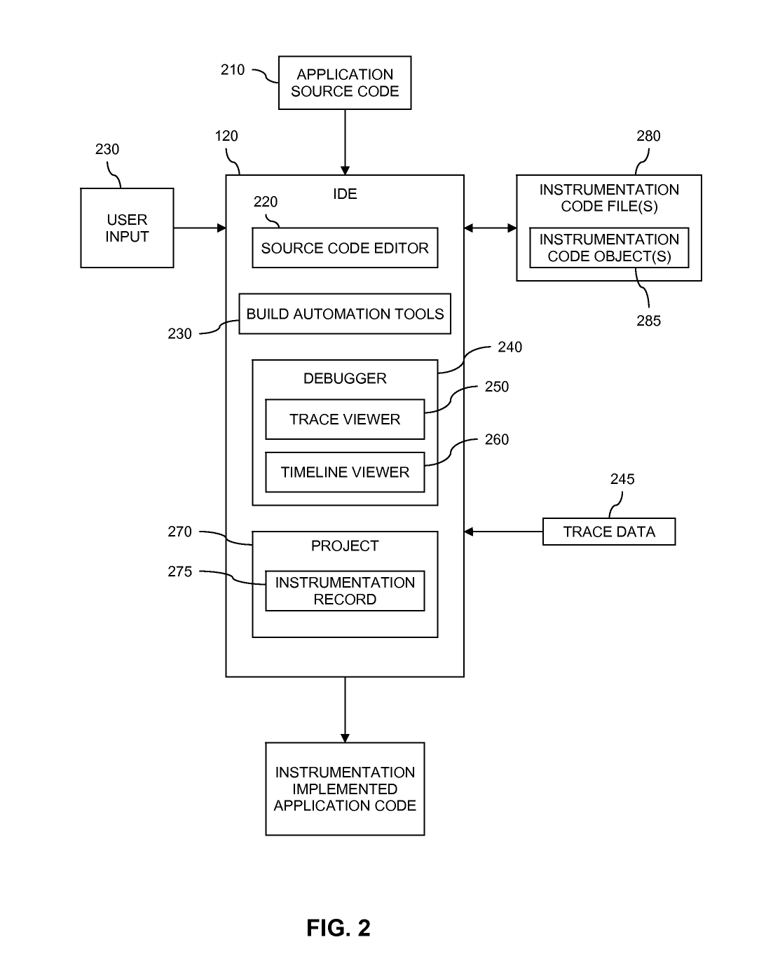

Referring now to FIG. 2, there is illustrated a simplified block diagram of an example of the IDE 120 illustrated in FIG. 1. An IDE, such as the IDE 120 illustrated in FIG. 2, is a software development tool that provides facilities to computer programmers for software development, and typically consists of a source code editor, build automation tools and a debugger. Some IDEs may further comprise a compiler, an interpreter, or both. One example of a conventional IDE is Eclipse™.

The IDE 120 is arranged to receive application source code 210, for example by loading one or more source code files. The IDE 120 comprises a source code editor component 220 that enables a user to edit the source code files 120, for example by way of user input commands illustrated generally at 230.

The IDE 120 further comprises build automation component 230 comprising one or more build automation tools. In this manner, the scripting of the compile and link steps for the various program code modules required to generate the binary code for the application program may be substantially automated. In addition, the IDE 120 may further comprise a compiler and/or interpreter (not shown) for implementing the generated compile and link steps. Alternatively, the compiling and linking may be performed by a discrete application (not shown) running on the computer system 110, or on another computer system altogether.

The IDE 120 further comprises a debugger component 240 arranged to receive debug information from previous execution runs of application program code under development, such as trace data 245. In the illustrated example, the debugger component 240 comprises a trace viewer component 250 for displaying to a user the trace data 245 for a previous execution run of the application program code under development. In the illustrated example, the debugger component 240 further comprises a timeline viewer component 260 for displaying to a user, for example, a timeline of function calls during a previous execution run of the application program code under development.

The IDE 120 may be arranged to manage the various resources associated with an application under development by assigning them to a specific ‘project’, such as illustrated generally at 270. Thus, in the illustrated example, the application source code 210, trace data 245, etc. associated with a particular application under development may be at least logically contained within the project 270 for that application under development.

Instrumentation is a known technique for providing analysis of application execution during development, and involves inserting instrumentation code into application code to be analysed that will provide an indication of the application progress during execution. For example, instrumentation probes may be added to implement a trace or the like during execution. Accordingly, the IDE 120 is arranged to enable such instrumentation code to be incorporated into the application program code being developed.

In particular, the IDE 120 in the illustrated example is arranged to enable instrumentation points to be defined within the application program code, and instrumentation code objects comprising instrumentation code to be associated with the defined instrumentation points. The IDE 120 is further arranged to cause the instrumentation code of the instrumentation code objects associated with the defined instrumentation points to be incorporated into the application program code prior to compilation of the application program code.

For example, an instrumentation point may be defined upon a user identifying a line of code within the application source code 210 via the source code editor component 220, and indicating that instrumentation code is desired to be inserted at that point within the application program code. Such an instrumentation point may be defined in any suitable manner. For example, an instrumentation point may be defined by recording a location of the instrumentation point within the application program code in an instrumentation record 275 for the application under development. For example, the line of code identified by the user may be recorded within the instrumentation record 275. Alternatively, an instrumentation point may be defined by inserting an instrumentation ‘tag’ into the application source code. For example, in the above example, such a tag may be inserted above/below the line indentified by the user.

Having defined an instrumentation point, one or more instrumentation code ‘objects’ may then be associated with the instrumentation point. For example, the IDE 120 may have access to one of more instrumentation files, illustrated generally at 280. Such instrumentation files 280 may form part of the local and/or remote development resources 130, 150 illustrated in FIG. 1. The, or each, instrumentation file 280 may comprise one or more instrumentation code objects 285. Each instrumentation code object 285 may comprise program code, for example in the form of source code, arranged to perform one or more instrumentation tasks when executed within an application program. For example, such a task may comprise writing trace data to a trace file, etc.

In some examples, a defined instrumentation point may be associated with one or more pre-existing instrumentation code objects 285, such as predefined instrumentation code objects 285 for performing ‘standard’ instrumentation functionality for a particular target hardware platform on which the application under development is intended to be executed. Additionally/alternatively, a defined instrumentation point may be associated with one or more custom instrumentation code objects 285, whereby a user is able to write, or otherwise provide, custom instrumentation code. Such custom instrumentation code may be saved, or otherwise stored, by the IDE 120 as an instrumentation code object 285 within an instrumentation code file 280 for subsequent access during compilation etc, as described below. Furthermore, such custom instrumentation code objects may be made available for use within projects 270 for other applications under development, locally and/or remotely.

Significantly, by defining instrumentation points within the application program code, and associating instrumentation code objects comprising instrumentation code with the defined instrumentation points in this manner, a user is able to manually implement instrumentation within the application program code without the need for inserting the instrumentation code into the application source code. Advantageously, this enables instrumentation code objects to be re-used for multiple instrumentation points within the application program code under development, and/or for multiple applications under development, substantially alleviating the need for manually rewriting instrumentation code for each instrumentation point and/or application under development. Furthermore, application code may be ported across different hardware architectures, maintaining the instrumentation points defined therefor, with any incompatibilities in instrumentation code across the different hardware architectures being easily managed through management of the association of instrumentation code objects with the defined instrumentation points.

Furthermore, because no instrumentation code is required to be inserted into the application source code 210, the application source code 210 remains ‘clean’, thereby enabling a user to modify the application source code 210 and/or the instrumentation code separately. Specifically, the use of defined instrumentation points in this manner facilitates the management of instrumentation within the application program code, without the instrumentation code obscuring the application program code itself. For example, the source code editor component 220 of the IDE 120 may be configurable to illustrate to a user the locations of instrumentation points within the application source code 210 using, for example, simple icons or other visual indications, thereby providing a user with a visual overview of the location of instrumentation points without the instrumentation code of the instrumentation code objects associated therewith obscuring the user's view of the application source code 210. Furthermore, the use of defined instrumentation points in this manner enables instrumentation implemented within the application program code to be managed separately from the application program code, and/or from the instrumentation code itself. For example, the IDE 120 may be configurable to display a list of defined instrumentation points for an application under development, and to categorise and/or arrange the displayed instrumentation points in accordance with various characteristics therefor, such as instrumentation point type (e.g. as described in greater detail below), instrumentation point attributes (e.g. as described in greater detail below), etc.

In some examples, a user may be able to define a type of instrumentation point. For example, a user may be able to define the type of an instrumentation point by selecting from a set of predefined instrumentation point types. A first such type of instrumentation point may comprise a software implementable instrumentation point, whereby instrumentation program code is simply inserted directly into the application program code at the appropriate location during (or prior to) compiling, and the required instrumentation task(s) is/are performed by simple execution of the inserted program code. An alternative type of instrumentation point may comprise a hardware implementable instrumentation point, whereby instrumentation code arranged to control one or more hardware blocks of the target hardware architecture is associated with the instrumentation point. For example, such instrumentation code may comprise hardware architecture specific program code to be inserted directly into the application program code at the appropriate location. Advantageously, the specific program code required to implement such a hardware implementable instrumentation need not be inserted directly into the application source code 210 by a user, with the defined instrumentation point only needing to be associated with the relevant instrumentation code object. As such, porting the application program code across multiple hardware architectures (including instrumentation points defined therefor) may be performed managed easily. Furthermore, the user defining the instrumentation points is not required to comprise detailed knowledge of the specific hardware architecture in order to implement the desired hardware implementable instrumentation if the appropriate instrumentation program code is already available.

In some examples, a user may be able to define such hardware implementable instrumentation points comprising one or more of:
a power hardware implementable instrumentation point;
a clock hardware implementable instrumentation point;
a trace hardware implementable instrumentation point; and
a multi-core synchronisation implementable instrumentation point.

In this manner, instrumentation may be implemented within the application program code enabling power and/or clock and or trace hardware blocks to be controlled, and also to control core synchronisation within a multi-core target hardware architecture for the application program code. Thus, such an instrumentation implementation enables not only the conventional collection of trace data etc, but also enables application behaviour to be modified through, for example, power/clock control to hardware components enabling a power profile for the application to be modified. Conventionally, such hardware implementable instrumentation was not possible through automated instrumentation techniques, and too time consuming and complex for conventional manual instrumentation techniques, due to the need for hardware specific knowledge etc.

It is further contemplated that a user may be able to define a custom type of instrumentation point.

In some examples, a user may be able to define one or more attribute(s) for each instrumentation point. For example, such an attribute may comprise a pre/post line of code attribute indicating whether the instrumentation code is to be inserted before or after the line of code at which at which the instrumentation point is located. Additionally/alternatively, such an attribute may comprise at least one condition parameter attribute indicating what (if any) conditions should be met in order for the instrumentation code to be inserted in to the application program code. For example, one such conditional parameter may comprise a variable value, the value of which may determine whether or not an instrumentation point should become ‘active’, whereby during execution of the application program code the respective instrumentation code is only executed if said variable value meets certain conditions. In one or more additional and/or alternative example, such a conditional parameter may comprise a condition based on which respective instrumentation code for the instrumentation point is inserted into the application program code. For example, a conditional parameter may comprise, say, a compilation macro. During compilation of the application program code, the compilation macro may be determined, for example based on one or more other compilation macros within the application program code, whether to include instrumentation code or not. Advantageously, such conditional parameters enable instrumentation to be more easily controlled, for example enabling the insertion and/or activation of multiple blocks of instrumentation code to be controlled as a group.

In some alternative examples, an instrumentation point may additionally/alternatively be defined upon a user identifying an event within a previous execution run of the application program code via the trace viewer component 250 of the IDE 120. For example, an instrumentation point may be defined upon a user identifying a particular trace event from a previous execution run of the application program code under development via the trace viewer 250, such as a trace event comprising an exceptionally large timestamp value, and indicating that instrumentation code is desired to be inserted at a corresponding point within the application program code. Furthermore, in some alternative examples, an instrumentation point may additionally/alternatively be defined upon a user identifying an event within a previous execution run of the application program code via a timeline viewer component 260 of the IDE 120. For example, an instrumentation point may be defined upon a user identifying a particular timeline event from a previous execution run of the application program code under development via the trace viewer 250, such as an out of order function call, and indicating that instrumentation code is desired to be inserted at a corresponding point within the application program code.

In this manner, instrumentation may be implemented on an event driven basis, making it easier for a user to implement instrumentation code to investigate certain events etc. without the need for the user to manually determine the relevant location within the application program code in which to insert instrumentation code.

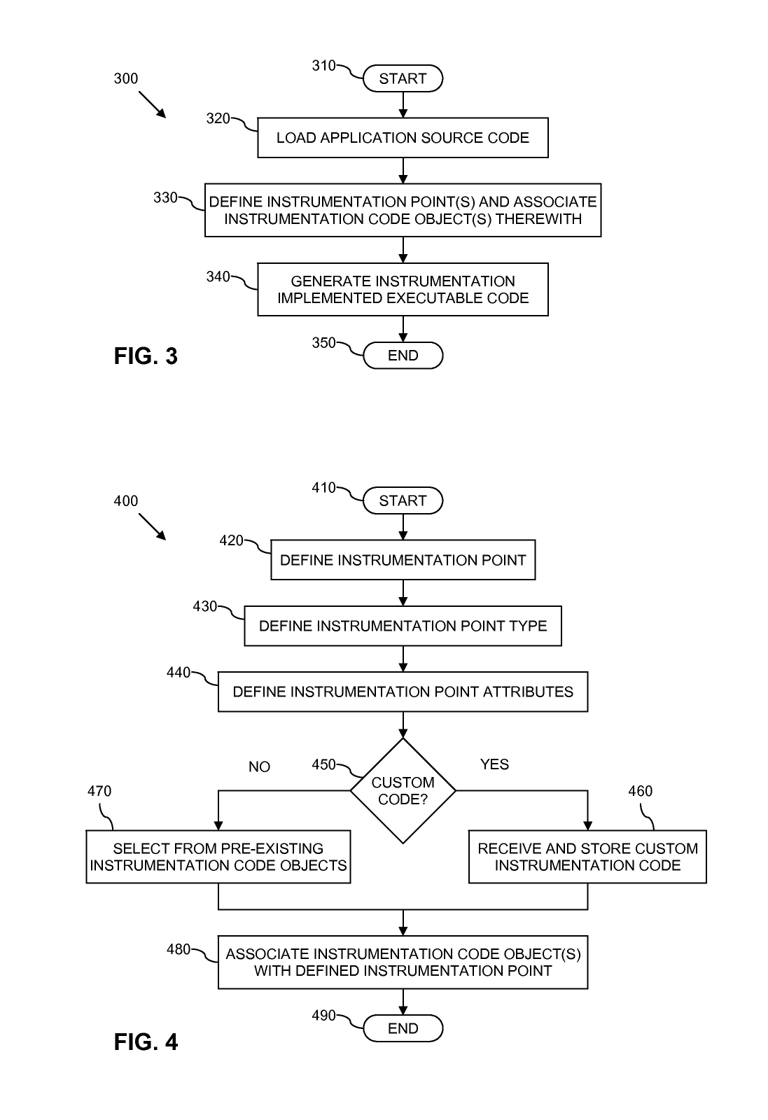

Referring now to FIG's 3 and 4, there are illustrated simplified flowcharts 300, 400 of an example of a method of implementing instrumentation code within application program code, such as ma be implemented within the apparatus of FIG. 1. Referring first to FIG. 3, the method starts at 310, and moves on to 320 where application program code for the application under development is loaded. Next, at 330, one or more instrumentation points are defined within the application program code, and one or more instrumentation code objects are associated therewith. Instrumentation implemented executable code (i.e. executable code for the application under development within which instrumentation code has been inserted) is then generated at 340, and the method ends at 350.

Referring next to FIG. 4, a simplified flowchart 400 of an example of defining an instrumentation point and associating therewith one or more instrumentation code objects, such as may be performed at 330 in FIG. 3, is illustrated. This part of the method starts at 410, and moves on to 420 where an instrumentation point is defined. For example, an instrumentation point may be defined upon a user identifying a line of code within the application source code via a source code editor component, and indicating that instrumentation code is desired to be inserted at that point within the application program code. Alternatively, an instrumentation point may be defined upon a user identifying an event within a previous execution run of the application program code via a trace viewer component. Alternatively, an instrumentation point may be defined upon a user identifying an event within a previous execution run of the application program code via a timeline viewer component. Next, at 430, an instrumentation point type is defined for the instrumentation point, and one or more attributes for the instrumentation point are defined at 440. For example, the instrumentation point may be defined as a software or hardware implementable instrumentation point, and one or more attributes such as pre/post line of code and/or one or more condition parameter attributes may be defined. The method then moves on to 450, where it is determined whether custom code is to be associated with the defined instrumentation point, or whether one or more pre-existing instrumentation code objects are to be associated with the defined instrumentation point. If it is determined that custom code is to be associated with the defined instrumentation point, the method moves on to 460, where such custom code is received from a user and stored (as one or more instrumentation code object(s)), for example within an instrumentation code file. Alternatively, if it is determined that one or more pre-existing instrumentation code objects are to be associated with the defined instrumentation point, the method moves on to 470 where one or more pre-existing instrumentation objects are selected. Next, at 480 the selected or received instrumentation code object(s) is/are associated with the defined instrumentation point, and the method ends, at 490.

As previously mentioned, the invention may be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, electrically erasable programmable read only memory (EEPROM), erasable programmable read only memory (EPROM), read only memory (ROM); ferromagnetic digital memories; magnetic random access memory MRAM; volatile storage media including registers, buffers or caches, main memory, random access memory (RAM), etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively ‘associated’ such that the desired functionality is achieved. Hence, any two components herein combined to achieve a particular functionality can be seen as ‘associated with’ each other such that the desired functionality is achieved, irrespective of architectures or intermediary components. Likewise, any two components so associated can also be viewed as being ‘operably connected’, or ‘operably coupled’, to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms ‘a’ or ‘an’, as used herein, are defined as one or more than one. Also, the use of introductory phrases such as ‘at least one’ and ‘one or more’ in the claims should not be construed to imply that the introduction of another claim element by the indefinite articles ‘a’ or ‘an’ limits any particular claim containing such introduced claim element to inventions containing only one such element, even when the same claim includes the introductory phrases ‘one or more’ or ‘at least one’ and indefinite articles such as ‘a’ or ‘an’. The same holds true for the use of definite articles. Unless stated otherwise, terms such as ‘first’ and ‘second’ are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of implementing instrumentation code within application program code, the method comprising:
defining, within a software development tool, at least one instrumentation point within the application program code;
associating, by the software development tool, at least one instrumentation code object with the at least one defined instrumentation point, wherein the at least one instrumentation code object comprises instrumentation code; and
incorporating, by the software development tool, the instrumentation code of the at least one instrumentation code object associated with the at least one instrumentation point into the application program code prior to compilation of the application program code.

2. The method of claim 1, wherein said defining the instrumentation point within the application program code is performed in response to at least one from a group consisting of:
a user identifying a line of code within the application code via the source code editor component of the software development tool,
a user identifying an event within a previous execution of the application program code via a trace viewer component of the software development tool, and
a user identifying an event within a previous execution of the application program code via a timeline viewer component of the software development tool.

3. The method of claim 1, wherein said defining the at least one instrumentation point within the application program code comprises at least one of
recording at least one location of an instrumentation point in an instrumentation record for an application under development or
inserting at least one instrumentation tag within the application program code.

4. The method of claim 1, wherein the method further comprises defining a type of instrumentation point for the at least one defined instrumentation point.

5. The method of claim 4, wherein said defining the type of instrumentation point for the at least one defined instrumentation point is selected from a group comprising at least one of:
at least one predefined instrumentation point type, and
a new instrumentation point type.

6. The method of claim 4, wherein said defining the type of instrumentation point for the at least one defined instrumentation point is selected from a group consisting at least one of:
a software implementable instrumentation point, and
a hardware implementable instrumentation point.

7. The method of claim 4, wherein said defining the type of instrumentation point for the at least one defined instrumentation point is selected from a group consisting at least one of:
a power hardware implementable instrumentation point,
a clock hardware implementable instrumentation point,
a trace hardware implementable instrumentation point, and
a multi-core synchronisation implementable instrumentation point.

8. The method of claim 1, wherein the method further comprises defining at least one attribute for the at least one defined instrumentation point.

9. The method of claim 8, wherein said defining at least one attribute for the at least one defined instrumentation point is selected from a group comprising at least one of:
a pre/post line of code attribute, and
at least one condition parameter attribute.

10. The method of claim 1, wherein the at least one instrumentation code object comprises at least one from a group comprising at least one of:
pre-existing instrumentation code, and
custom instrumentation code.

11. (canceled)

12. An apparatus for implementing instrumentation code within application program code, the apparatus being arranged to:
define at least one instrumentation point within the application program code;
associate at least one instrumentation code object with the at least one defined instrumentation point, the at least one instrumentation code object comprising instrumentation code; and
cause the instrumentation code of the at least one instrumentation code object associated with the at least one instrumentation point to be incorporated into the application program code prior to compilation of the application program code.
